(19) United States
(12) Patent Application Publication
(10) Pub. No.: US 2015/0156481 A1
(43) Pub. Date: Jun. 4, 2015

(54) HEADS UP DISPLAY (HUD) SENSOR SYSTEM

(71) Applicant: Kenneth Varga, Phoenix, AZ (US)

(72) Inventor: Kenneth Varga, Phoenix, AZ (US)

(73) Assignee: REAL TIME COMPANIES, Phoenix, AZ (US)

(21) Appl. No.: 14/616,181

(22) Filed: Feb. 6, 2015

Related U.S. Application Data
(63) Continuation-in-part of application No. 13/385,038, filed on Jan. 30, 2012, now abandoned.
Application No. 13/385,038 is a continuation-in-part of application No. 14/480,301, filed on Sep. 8, 2014.
Application No. 14/480,301 is a continuation-in-part of application No. 13/385,039, filed on Jan. 30, 2012, now abandoned.
Application No. 14/480,301 is a continuation-in-part of application No. 14/271,061, filed on May 6, 2014.
Application No. 14/271,061 is a continuation-in-part of application No. 12/460,552, filed on Jul. 20, 2009, now abandoned.
Application No. 12/460,552 is a continuation-in-part of application No. 12/383,112, filed on Mar. 19, 2009, now abandoned.
(60) Provisional application No. 61/575,131, filed on Aug. 16, 2011.
(60) Provisional application No. 61/626,701, filed on Sep. 30, 2011.
(60) Provisional application No. 61/629,043, filed on Nov. 12, 2011.

(51) Int. Cl. H04N 13/04; H04N 13/02

(52) U.S. Cl. CPC H04N 13/044; H04N 13/0239; H04N 13/0282; H04N 13/0497; H04N 13/0447

(57) ABSTRACT

This application relates to a stereoscopic multi-angle camera system allowing a user to take pictures and/or video and record stereoscopic sound not only as a spherical view but also using stereoscopic imaging/recording by having two cameras, global positioning systems, magnetic sensors, environment sensors, and/or two microphones per solid angle of view such that omnidirectional visual and omnidirectional acoustic depth perception may be achieved.

### CROSS REFERENCE TO RELATED APPLICATIONS

The present application claims priority under 35 U.S.C. §120 as a continuation-in-part of Non-Provisional patent application Ser. No. 13/385,038, entitled “Heads Up Display (HUD) Sensor System, which was filed on Aug. 16, 2011 and which is incorporated by reference in its entirety herein. This application also claims priority under 35 U.S.C. §120 as a continuation-in-part of Non-Provisional patent application Ser. No. 14/480,301, which was filed on Sep. 9, 2014 and which is incorporated by reference in its entirety herein.

### FIELD

Aspects of the present disclosure involve three dimensional (3D) omni-directional stereoscopic immersion and/or telepresence systems and methods where recording and/or playback and/or live play of video/image and/or audio experiences from one or more computing devices located at one or more locations may be achieved.

### BACKGROUND OF THE INVENTION

Aspects of the present disclosure relates to using camera systems as well as audio systems to capture omni-directional depth data, to capture and produce live-feed or playback of remote reality, generalized reality, or the combination thereof. There are many techniques in the prior art for capturing three dimensional (environment) data from various types of sensors from depth cameras (RGB-D: red, green, blue, depth via time of flight or structured light with stereo), laser sensor systems, radar, active and passive acoustic systems, as well as from camera images. Prior art also includes using one or more panoramic omni-directional cameras using mirrors, as well as arrays of multiple cameras that point in different directions, as well as arrays of multiple microphone arrays for recording/capturing of sound in different directions.

### OBJECTS OF THE INVENTION

This application relates to a stereoscopic multi-angle camera system allowing a user to take pictures and/or video and record stereoscopic sound not only as a spherical view but also using stereoscopic imaging/recording by having two cameras, global positioning systems, magnetic sensors, environment sensors, and/or two microphones per solid angle of view such that omnidirectional visual and omnidirectional acoustic depth perception may be achieved.

The stereoscopic cameras and microphones may be zoomable, wide angle cameras and microphones positioned such that every direction or any set of directions may be captured in a single image frame and sound recording group while simultaneously giving depth perception with spherical stereoscopic perspective view and hearing capability. The picture (s), video(s), sounds may be viewed and heard on the sensor system itself or by transferring them using a memory card, thumb drive, wirelessly, or by cable to another computing device.

For viewing the images external to the camera and sound recording system, a Heads Up Display (HUD) or other display and sound device may be used that detects the orientation of the user's head, eyes, zoom level, and/or other orientation control device position selected and calibrated to the image and/or video angles and incorporating depth perception through stereoscopic projection onto the user's eyes. This may be done with orientation and rotational sensors as well as translational or other sensors correlated with known camera and microphone angles in the recorded or live data. Another method for viewing and/or otherwise accessing the images and/or video captured by the cameras and/or the microphone involves using 3D (three dimensional) glasses with a monitor. More specifically, a plain monitor, television, computer, client device, mobile device, or other type of display may be used to view the images and/or video while using cursor keys, mouse, joystick, or other controlling mechanism to adjust the view in 3D.

According to one embodiment, the stereoscopic sound is captured with the spherical sensor system such that sound sources are also captured directionally and stereoscopically and correlate with the 3D spherical imaging. This is achieved by having an omnidirectional microphone or microphones oriented such that the sound captured is tagged relative to image data such that when played it is as if a person's head and ears were physically at the origin of the spherical camera facing in a specific gaze direction. The tagged image data may be applied or otherwise used in various contexts including video games, police and fire department surveillance/security equipment, medical procedures, among others. For example and in one embodiment, the tagged image data and/or 3D spherical images may be used to generate unique points of view of a live sporting event, such as a football game. For example, the tagged images may be used to generate 3D spherical images that emulate the perspective of viewing the football game at the fifty (50) yard line, directly behind the goal post, and/or the like.

In one embodiment, multiple microphones may be used such that every solid angle or a set of solid angles are covered, such that head orientation may be replicated with ears corresponding to direction relative to head orientation. This may be achieved by orienting a microphone at about +90 degrees and a microphone at about −90 degrees from the camera head gaze direction or a nearer equivalent to replicate acoustic characteristics of human ears with respect to human head gaze direction, thus achieving the approximate position of the human ears with respect to the human head gaze.

For hearing the sounds, a speaker or speakers, headphones, or a surround sound speaker system may be correlated with the orientation data of the listener, such as for example, employing head eye orientation sensors, cursor, joystick, or other angular feedback control mechanisms, and/or the like. The sounds may be heard stereoscopically as if the person's ears were at the origin of the spherical camera system about +/−90 degrees off the head gaze direction effectively emulating orientation of ears. This system enables a user to remotely detect (or program to calculate) the origin of a sound source through computation or by allowing detection of the movement of the user'(s) head orientation.

A further embodiment for the playback may be a stereoscopic spherical (or hemispherical) display theatre with a display floor, walls, and ceiling where all the 3D stereoscopic images are projected or displayed onto the sphere (or hemisphere) along with sounds presented spherically (or hemi-spherically).

### SUMMARY

Aspects of the present disclosure include omnidirectional camera and audio methods, systems, and non-transitory computer readable mediums. The methods, system and/or non-transitory computer readable mediums include a right eye camera and a left eye camera, the right eye camera including a first set of lenses and the left eye camera including a second set of lenses that correspond to the first set of lenses, wherein a first lens of the set of lenses of the right eye camera captures a first image of an environment and a second lens of the set of lenses of the right eye camera captures a second image of the environment, and wherein the first and second image captured by the right eye camera are captured at a specific degree of difference in relation to a third image captured by the left eye camera. The methods, system and/or non-transitory computer readable mediums further include at least one processor in operative communication with the right eye camera and the left eye camera, the at least one processor to obtain a distance between the first lens of the first set of lenses and the second lens of the first set of lenses and overlay the first image and the second image, based on the determined distance, to generate at least one overlayed stereoscopic image. The at least one processor is further configured to generate at least a portion of a stereoscopic spherical display based on the at least one overlayed stereoscopic image and the third image.

### DRAWINGS

FIG. 1A is an example of a planar view of the sensor system showing a planar slice, according to one embodiment of the present disclosure.

FIG. 1B is an example of a perspective view of the sensor system, according to one embodiment of the present disclosure.

FIG. 2 is a block diagram of the sensor system showing major component details interfacing with an experience sharing and controlling system, according to one embodiment of the present disclosure.

FIG. 3 is a block diagram of the experience sharing and controlling system showing major component details interfacing with a user whereby the user is able to select, control, display, zoom, and/or see, and hear the data in a desired gaze direction in real time or as play back, according to one embodiment of the present disclosure.

FIG. 4 is a general process flow chart that allows for the displaying, speaking, and controlling of the data, according to one embodiment of the present disclosure.

FIG. 5A is a general process flow chart for generating a stereoscopic spherical display, according to one embodiment.

FIG. 5B is an illustration of a one square face module, according to one embodiment.

FIG. 6 is a block diagram of a field environment including fuel tanks, according to one embodiment of the present disclosure.

FIG. 7 is a block diagram of a computing device implementing aspects of the present disclosure, according to one embodiment of the present disclosure.

### DETAILED DESCRIPTION

Aspects of the present disclosure describe an omnidirectional stereoscopic camera and microphone system (referred to as a “sensor system”) that incorporates an ability to simultaneously capture spherical stereoscopic images and/or videos and/or spherical stereoscopic sound. Subsequently, the disclosed systems may display and/or otherwise provide the images, video, and/or sound, stereoscopically, at a select angle and/or zoom level or from all (or a set of) directions simultaneously or in rapid sequence. The system allows for immersion of a remote environment, as well as detailed environmental image and sound data geometry.

In other embodiments, the omnidirectional stereoscopic camera and microphone system may consist of one or more left and right eye camera and microphone pairs positioned relative to each other such that omnidirectional play back or a live feed of video and omni-directional acoustic depth perception can be achieved. A user or users may select a direction of gaze as well as to hear, and share the experience visually and audibly with the system as if the user or users are physically present. The sensor system orientation is tracked by a compass and/or other orientation sensors enabling users to maintain gaze direction, independent of sensor system orientation changes.

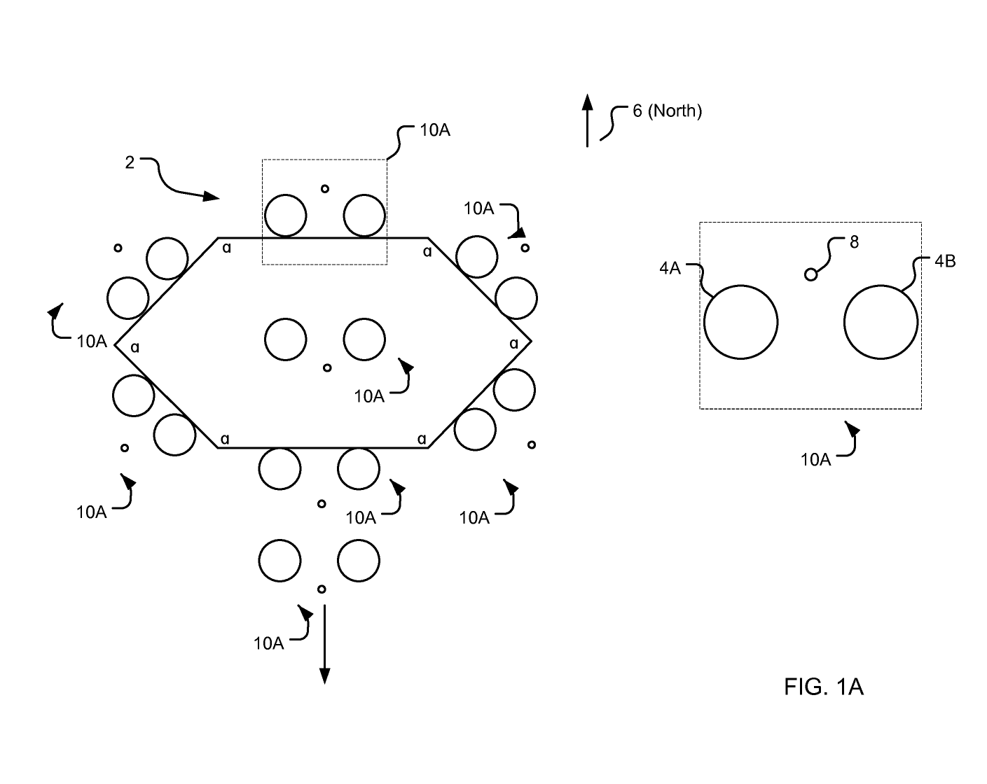

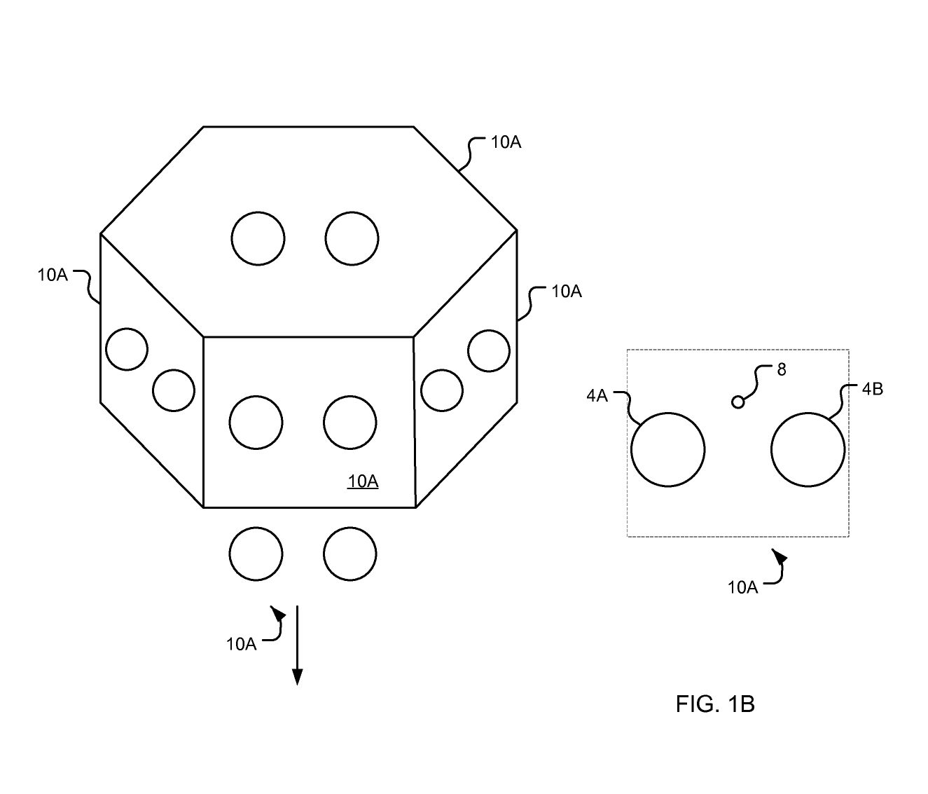

FIG. 1A is an example planar slice of a sensor system 2 looking down from above, and a perspective view of the sensor system FIG. 1B with reference orientation to the north, as illustrated at 6. Left eye camera 4A, right eye camera 4B, are shown as a pair with microphone 8 as one square face module 10A. For the sensor system 2 shown in FIG. 1 B, there are eight surfaces containing a square face 10A, each having two cameras 4, one for the left eye 4A, and one for the right eye 4B, and a microphone 8 used to interpolate spherical directionally dependent data so that it is corresponding to the relative eye and ear orientation of a user's head gaze direction. One of the surfaces 10A is pointing upward to the north, and one of the surfaces 10A is pointing downward. In one embodiment, six of the eight surfaces may be arranged in a hexagon shape (excluding the top and bottom edges), in which the six surfaces of equal length and the internal angles “α” of the hexagon equate to seven hundred and twenty degrees (720), although other shape and arrangements are contemplated.

The cameras 4 (4A and 4B) may be made gimbaled and zoom-able via electronic controls, and can also contain a combination of a zoom-able camera as well as a fish eye lens camera, or be a catadioptric mirror camera or other suitable camera system such as infrared or ultraviolet or any combination. There may be any number of cameras, microphones and surfaces limited to the geometry of the cameras 4 and microphones 8 and supporting structure. For clarity, power and data lines are not shown in the figures. If occlusion occurs on any mounting surface, external camera(s) 4 and micro-phone(s) 8 may be optionally placed on the opposite end of the mounting surface or elsewhere (thus no longer occluded) and integrated into the sensor system 2. The sensor system 2 may be mounted anywhere, and may be incorporated into a helmet, and/or the sensor system 2 may be combined and integrated into the experience sharing system 26 as a Heads Up Display (HUD). Other camera types 4 may be used, and the invention is not limited to the geometry or camera type. For instance, a single omnidirectional mirror lens camera may be used in place of multiple cameras. The cameras are not limited to be just visible cameras, they may be infrared, ultra-violet, or other, or any combination. Data from multiple cameras and camera types may be combined and/or aligned and/or overlaid to enhance the understanding and utility of the data.

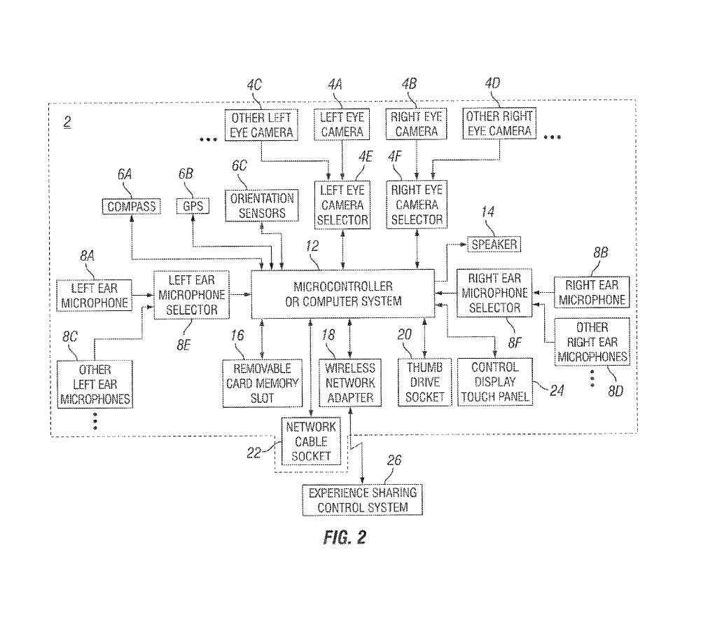

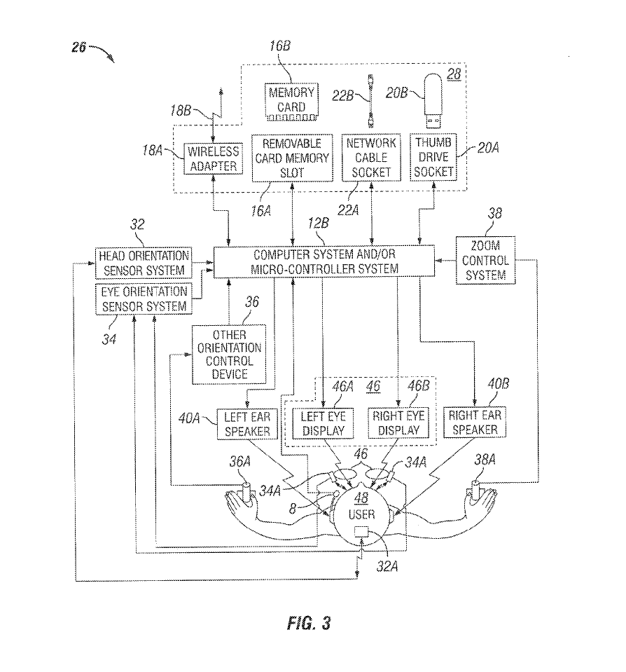

FIG. 2 is a block diagram of the sensor system 2 connected to experience (perceptual) sharing and controlling system 26 with the major block components for the sensor system 2 shown. Compass 6A, Global Positioning System (GPS) or equivalent 6B, orientation sensors 6C are shown connected to micro-controller or computer system 12. The orientation sensors may be inertial reference, contain accelerometers, or laser gyroscopic sensor or other type of orientation sensor system to acquire sensor system orientation 2. The orientation sensors 6C may be expanded to include other sensor types for different uses to improve experience capturing, such as humidity sensors, wind speed and direction sensors, pressure sensors, mass spectrometer sensors to capture smell, or other sensors of any type to help with capturing and reproducing the immersion experience. The experience sharing and controlling system 26 is similar to a tele-presence or remote immersion system that allows a remote user or users to experience another location or play back an experience. The computer 12 may be a microcontroller and/or computer system that integrates routes, and controls data and power with the other system components shown. Left eye camera 4A or other left eye cameras 4C are selected by left eye camera selector 4E or are simultaneously routed to computer 12. Right eye camera 4B or other right eye cameras 4D are selected by right eye camera selector 4F or are simultaneously routed to computer 12. Left ear microphone 8A and other left ear microphones 8C are selected through left ear microphone selector 8E or are simultaneously routed to computer 12. Right ear microphone 8B and other right ear microphones 8D are selected through right ear microphone selector 8F or are simultaneously routed to computer 12. Having positioned left and right ear microphones and camera eyes allows a user to experience visual and acoustic depth perception of a remote environment at all angles of head and eye orientation. Data is transferred to experience sharing and controlling system 26 through removable card memory slot 16 and memory card (16B of FIG. 3) network cable socket 22, wireless (WiFi, Bluetooth, Infrared-IR, or other suitable wireless technology) network adapter 18 via wireless signal (18B of FIG. 3), and/or thumb drive socket 20. Alternatively, the experience may be recreated on the remote sensor system 2 itself via a control touch panel (or other) playback system 24 and speaker(s) 14 that may be projected from the sensor system 2 controlled by image or other sensor sensing techniques as well as through voice command through any microphone 8 or just be an ordinary touch screen display on an edge with space available, or internally where the sensor system opens up using a hinge (not shown in the figure) with an internal control display touch panel 24.

FIG. 3 is a block diagram of the major components of the remote experience sharing and controlling system 26 of which may be duplicated in desired portions as control and display touch panel (or other interface) playback system 24 and speaker(s) 14 of FIG. 2 or by other means. Computer system and/or microcontroller system 12B controls, routes, and integrates data and power between devices within the remote experience sharing and controlling system 26 and user 48 as well as to and/or from sensor system 2 of FIG. 1A, FIG. 1B, and FIG. 2. The remote experience sharing and controlling system 26 is connected to any one or multiple methods via wireless adapter 18A through wireless signal 18B, as well as through removable card memory slot 16A and memory card 16B, as well as through network cable socket 22A, network cable 22B, thumb drive (may be a Universal Serial Bus, USB or other bus) socket 20A and thumb drive 20B. User 48 control and feedback is established through head 32 and eye 34 orientation sensor systems connected to user 48, head sensor 32A, eye sensors 34A, other orientation control device 36 to other human machine interface device 36A, as well as zoom control system 38 through zoom control human machine interface device 38A, all as a method to interface to computer system 12B. Head orientation 32 and eye tracking 34 sensor systems as well as display glasses 46 do not have to be mounted on user 48 as they may be remote sensing and/or displaying systems as well. Combination stereoscopic display 46 may be one or more displays, such as a left eye display 46A, and right eye display 46B, and/or utilize polarized or colored glasses 46. Stereoscopic sound is presented to the user through left ear speaker 40A, and right ear speaker 40B from computer system 12B with appropriate amplification and digital to analog conversion inside computer system 12B. User 48 speech recognition control may be accomplished through microphone 8 connected to computer system 12B with appropriate amplification and analog to digital conversion inside computer system 12B.

Speakers 40A and 40B may be earphones where sound may be reproduced based on head orientation, thus requiring only one speaker per ear, but still generating surround sound and still further, headphones may be such that they generate surround sound internally by having multiple directions of sound source per ear (multiple speakers producing multiple acoustic bearings per ear or having the net effect of) or the two external speakers can stereoscopically generate the variance required based on the head orientation (using two or more speakers) by use of time delay between speaker headsets. Objects manipulated in computer space may be moved towards the user's head and the sound may be adjusted in 3D, amplified and directed based on objects orientation and distance between user's head. As an example, a user can pick up a virtual seashell and move it close to their ear and hear the sound of a seashell, or a recording or a live play of the same location on the sensor system 2 may be remotely experienced.

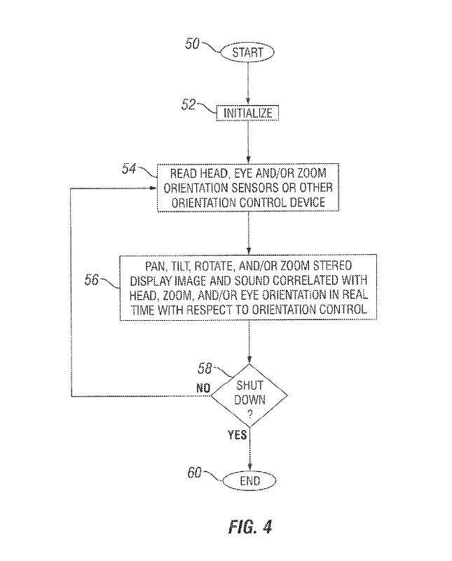

FIG. 4 is a general flow chart of the main system process for the microcontroller and/or computer system 12 and/or 12B where the process starts at 50 and initializes at process block 52 where the head, eye, zoom or other orientation sensor devices are read at process block 54, and then the process pans, tilts, rotates, and/or zooms the stereoscopic display image and sound correlated with head, zoom, and/or eye orientation in real time with respect to the orientation control at process block 56, whereby if the system shuts down at decision block 58, the process ends at 60 or continues back to reading the head, eye, zoom or other orientation sensor devices 54. If display system is a spherical (or hemispherical) theatre system, then process steps 54 and 56 may not be necessary.

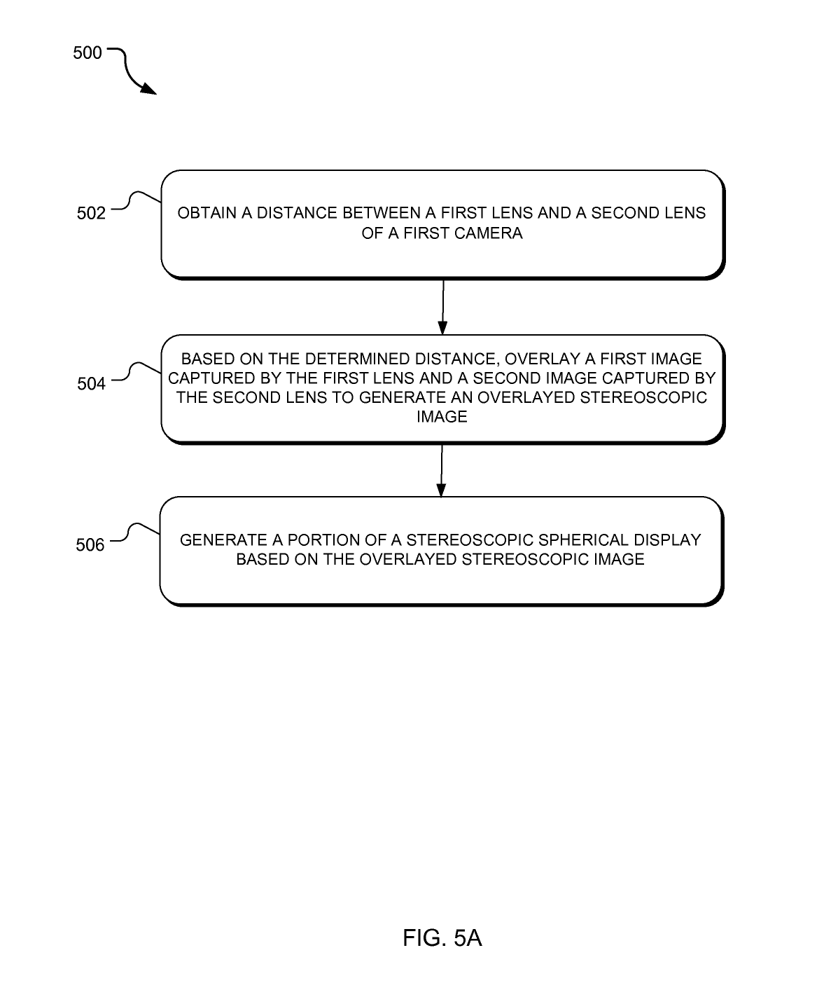

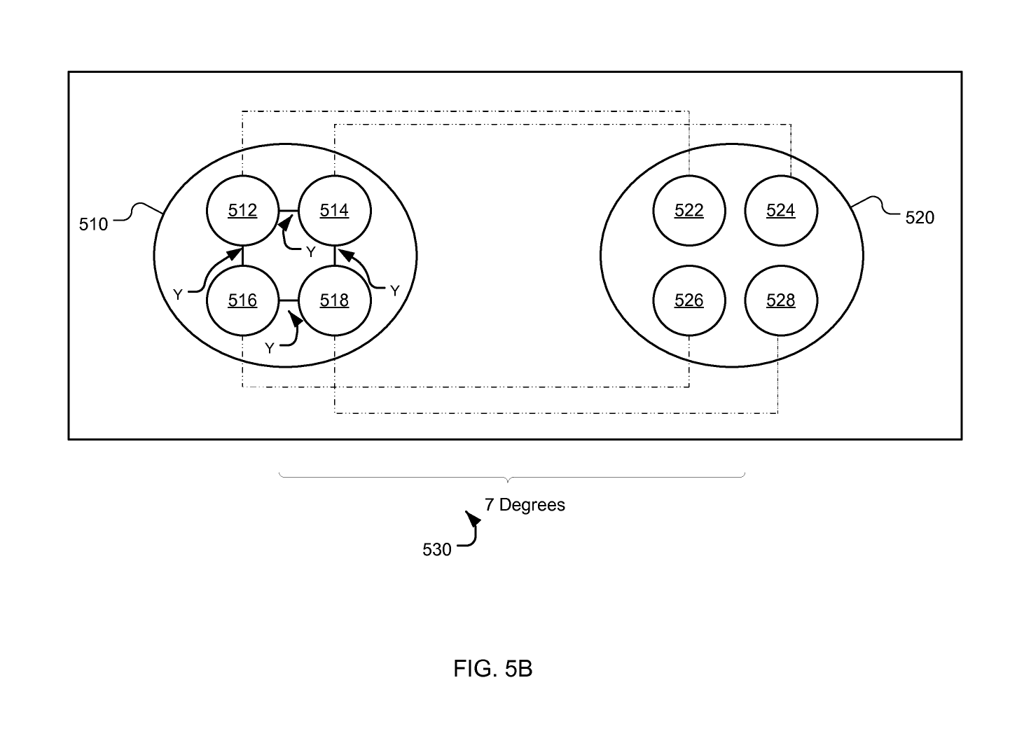

FIG. 5A illustrates an example method and/or process 500 for capturing images to generate a stereoscopic spherical display, according to one embodiment. As illustrated, process 500 begins with obtaining a specific distance between a first lens and a second lens in a set of lenses of a first camera and/or a corresponding lens included in a set of lenses of a second camera (operation 502). FIG. 5B illustrates a first camera 510 and a second camera 520 both of which include a set of four lenses, according to one embodiment. As illustrated, the first camera 510 includes four lenses 512, 514, and 516 all of which are of the same distance and angle apart. The second camera 520 includes four lenses 522, 524, 526 and 528 all of which are the same distance and angle apart. The lenses of both the first camera 510 and the second camera 520 may be of any type, such as for example Infra-red, Ultra-violet, Low-light, visual, regular, night vision, among others.

According to one embodiment, each lens in the first camera 510 is located a specific distance and angle from every other lens included in the camera. Thus, as illustrated, lens 512 is located “Y” distance from lenses 514 and 516. Lens 518 is “Y” distance from camera lens 516 and 514, and so on. The distance between lenses 512 and 518 and 514 and 516 may be calculated based on the distance “Y” between the other lenses. Stated differently, since the distance “Y” is known between lenses 512 and 514 and the distance “Y” is known between lenses 512 and 516, the distance between 512 and 518 may be calculated based on such distances. The second camera 520 includes a set of lenses that are also “Y” distances apart in a similar manner as the lenses of the camera 510.

Referring again to camera 510, in one embodiment, each lens in the first camera 510 corresponds to a specific lens of the second camera 520. In the illustrated embodiment, the lens 512 of the first camera 510 corresponds to the lens 522 of the second camera 520 and is located at a distance “X from lens 512.” The lens 514 of the first camera 510 corresponds to the lens 524 of the second camera 520 and is located at a distance “X” from lens 514. The lens 516 of the first camera 510 corresponds to the lens 526 of the second camera 520 and is located at a distance “X” from lens 516. The lens 518 of the first camera 510 corresponds to the lens 528 of the second camera 520 and is located at a distance “X” from lens 518.

The distance determined between respective lenses in the first camera and/or a particular lens of the first camera and its corresponding lens in the second camera is used to generate stereoscopic images for playback, such as for example in a spherical display device (operation 504). More specifically, separate stereoscopic and/or digital images may be captured by the various lenses of each camera 510 and 520. For example and in one embodiment, an image may be captured by the lenses of the first camera 510 and an image may be captured by the lenses of the second camera 520. The images received for each eye may include a difference of seven (7) degrees, as illustrated at 530. Stated differently, the digital images for the right eye may be, in one embodiment, of a 7 degree difference in relation to the digital images for the left eye. Receiving images for each eye at a seven degree difference enables images for both eyes to be combined to provide depth-perception to the various views identified and/or generated within the three-dimensional stereographic space displayed at the HUD display device.

As noted above, the distances between each lens in each camera may be used to overlay images into a single stereoscopic image for inclusion into a spherical display and/or omnidirectional playback and/or live feed of video. More specifically, as noted above, each lens of the set of lenses of a respective camera (e.g., right or left) is separated a certain distance from each other. Thus, the distances may be used to overlay the images into a single image for each eye camera. For example and with reference again to FIG. 5, at least two images captured by at least two lens included in the camera 510 may be overlayed based on the distance between the respective lenses. Thus, assuming the lenses were lenses 512 and 514 of camera 510, the images captured by each lens could be overlayed based on the distance “Y” existing between the two lenses. More specifically, the image obtained corresponding to lens 512 may be adjusted by a distance “Y” to be in alignment with the image captured by lens 514. As another example, the image obtained corresponding to lens 518 may be adjusted by a distance “Y” to be in alignment with the image captured by lens 516. In yet another example, the image obtained corresponding to lens 512 may be adjusted a certain distance to be in alignment with the image captured by lens 518, based on the distance “Y” between camera 512 and 514, and a distance “Y” between 514 and 518. Overlaying images captured by lenses included the camera 520 may be performed in a similar manner.

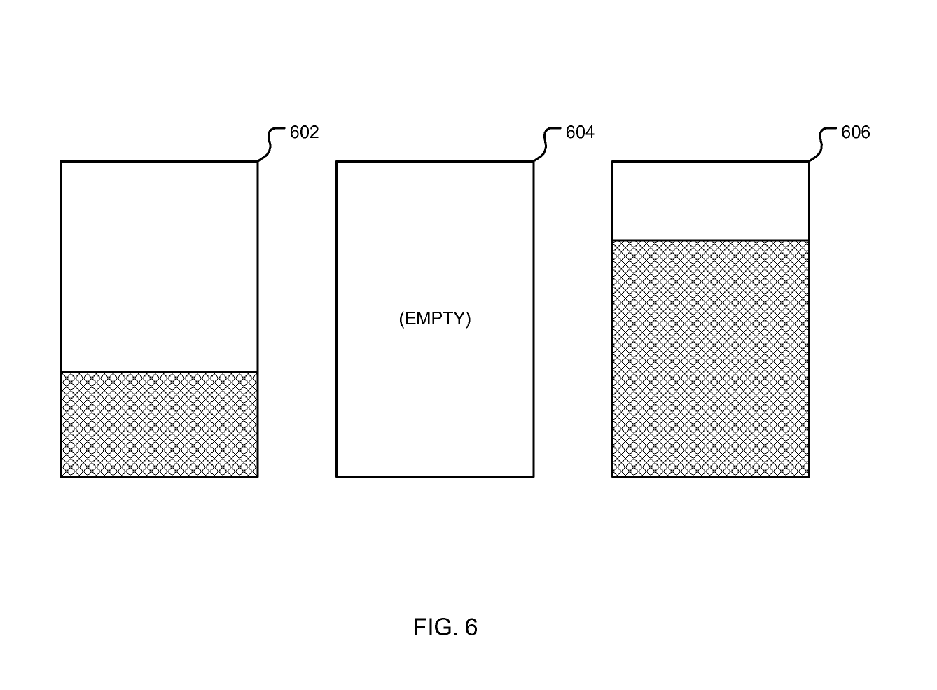

FIG. 6 provides an illustrative example of overlaying images captured from a right eye camera and/or left eye camera, according to one embodiment. In the illustrated embodiment, assume a user, such as a soldier is in a potentially hazardous field environment analyzing three fuel tankers 602, 604, and 606. Assume that the tank 604 includes no fuel, tank 602 includes a low level of fuel, and tank 606 includes a higher level of fuel.

Since the fuel tankers contains flammable material that could ignite and cause a hazardous environment for the solider, the soldier may be interested in analyzing the tanks to determine how much fuel is contained in each tank, if any. To do so, the soldier may employ a stereoscopic camera system (e.g., the system of FIG. 1A-1B) to capture images of the tanks and overlay one or more of the images to gain information about the tanks that could not otherwise be determined from single individual images. Using the stereoscopic camera system allows the solider to learn information and/or characteristics about the fuel tanks even though the solider cannot directly see into the tanks.

In one embodiment, the stereographic system may include a right eye camera and a left eye camera as described in FIG. 5B. Each camera lens within each camera provides different information and/or image characteristics, attributes, and/or perspectives about the environment (e.g., the tanks) that the lens is capturing and that the other lenses may not provide. For example, the right eye camera 510 (could also be the left eye camera) may employ a thermal infra-red lens to capture images of each of the tanks 602, 604, and 606 that provide heat-related information (e.g., heat signatures) about the fuel tanks. In one embodiment, the temperatures of the fuel and air will be different so a different heat signature will be displayed, thus allowing for a “virtual” look inside the tank that identifies or otherwise illustrates the fuel level. Additionally, the right eye camera 510 may include an ultra-violet lens to capture images of each of the tanks 602, 604, and 606 that provide other characteristic/attribute information about the amount of fuel included in the tanks 602, 604, and 606. In yet another example, the right eye camera 510 may include a video lens that provides video of the tanks 602, 604, and 606.

Any of the images captured by one or more of the different lenses (e.g., the infra-red lens and the ultra-violet lens) may be overlayed together based on the distance between the infra-red lens and the ultra-violet lens, thereby generating a single comprehensive image. In the illustrated embodiment, the single image may enable the solider to be able to visually determine the different levels of fuel included in each tank, and thus identify tank 606 as potentially being the most dangerous because it includes the most fuel. Thus, the soldier may not want to hide behind the tank with the most fuel, as any enemy fire into close proximity of the tank area might ignite the tank and cause and explosion, putting the soldier's life at risk.

In one embodiment, to overlay the images, individual stereoscopic spheres may be generated for each camera lens that captured an image to be overlayed. To generate the stereoscopic sphere for each respective lens, the captured image(s) for each lens may be digitally stitched together in real-time to generate the three-dimensional stereographic sphere. Generally speaking, stitching refers to the process of combining multiple photographic images with overlapping fields of view to produce a single, high-resolution image. Thus, the sensor system 2 may implement or otherwise initiate a stitching process that processes the various images received from a specific camera lens to generate a single high-resolution image in the form of a stereoscopic sphere. Then each individual stereoscopic sphere corresponding to each camera lens may be rotated based on “Y” to obtain the proper perspective for the user, thereby overlaying the stereoscopic spheres into a single point of view.

Referring to the fuel tank example above, individual stereoscopic spheres may be generated for the ultra-violet lens and the thermal infra-red lens that captured images of the fuel tank environment. Subsequently, the stereoscopic spheres may be combined and rotated into both the x and y direction to obtain the proper perspective of the user.

Once the images have been overlayed to generate the single image (e.g., the stereographic image), the image may be integrated into a spherical display that is provided at an interface, such as the HUD described above. The HUD is fully functional and able to be used by users. In an alternative embodiment, the image may be provided to users in the form of omnidirectional playback or live video in conjunction with any audio captured by the microphones described herein.

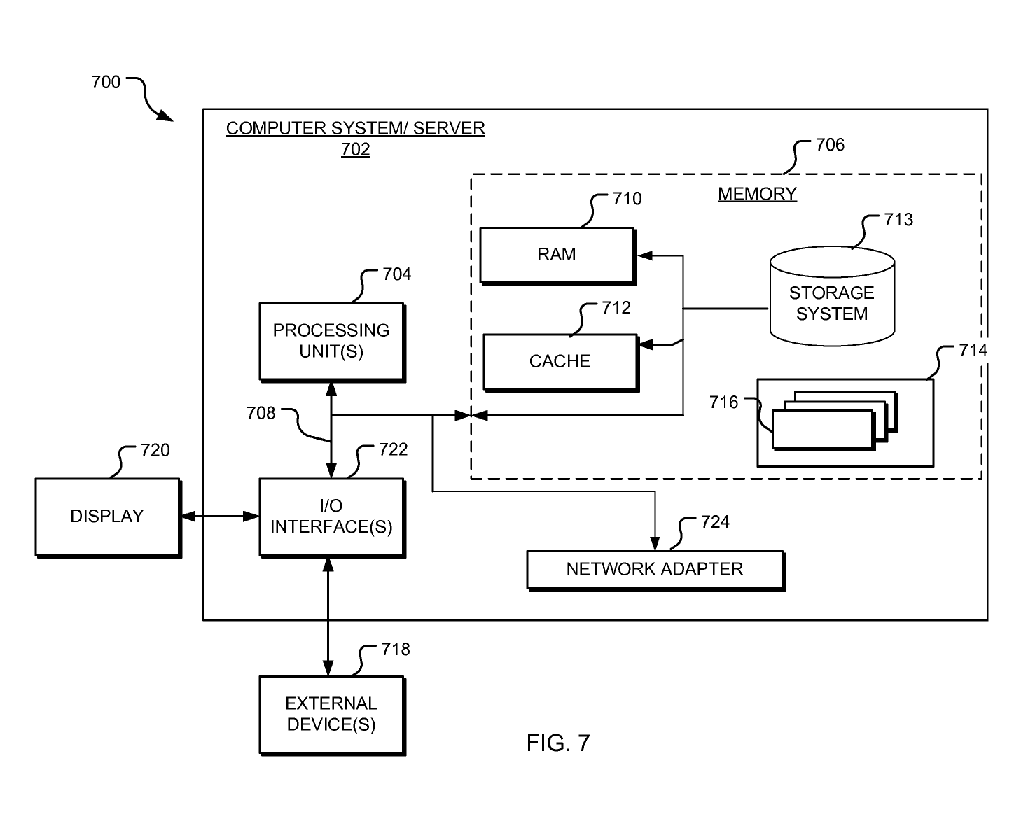

FIG. 7 illustrates an example of a computing node 700 which may comprise an implementation of the microcontroller or computer system 12. The computing node 700 represents one example of a suitable computing device and is not intended to suggest any limitation as to the scope of use or functionality of embodiments of the invention described herein. Regardless, the computing node 700 is capable of being implemented and/or performing any of the functionality described above.

As illustrated, the computer node 700 includes a computer system/server 702, which is operational with numerous other general purpose or special purpose computing system environments or configurations. Examples of well-known computing systems, environments, and/or configurations that may be suitable for use with computer system/server 702 may include personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 702 may be described in the general context of computer system executable instructions, such as program modules, being executed by a computer system. Generally, program modules may include routines, programs, objects, components, logic, data structures, and so on that perform particular tasks or implement particular abstract data types. Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 702 in computing node 700 is shown in the form of a general-purpose computing device. The components of computer system/server 702 may include one or more processors or processing units 704, a system memory 706, and a bus 708 that couples various system components including system memory 706 to processor 704.

Bus 708 represents one or more of any of several types of bus structures, including a memory bus or memory controller, a peripheral bus, an accelerated graphics port, and a processor or local bus using any of a variety of bus architectures. Such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and non-volatile media, removable and non-removable media.

System memory 706 may include computer system readable media in the form of volatile memory, such as random access memory (RAM) 710 and/or cache memory 712. Computer system/server 702 may further include other removable/non-removable, volatile/non-volatile computer system storage media. By way of example only, storage system 713 may be provided for reading from and writing to a non-removable, non-volatile magnetic media (not shown and typically called a “hard drive”). Although not shown, a magnetic disk drive for reading from and writing to a removable, non-volatile optical disk such as a CD-ROM, DVD-ROM or other optical media may be provided. In such instances, each may be connected to bus 708 by one or more data media interfaces. As will be further depicted and described below, memory 706 may include at least one program product having a set (e.g., at least one) of program modules that are configured to carry out the functions of embodiments of the invention.

Program/utility 714, having a set (at least one) of program modules 716, may be stored in memory 706, as well as an operating system, one or more application programs, other program modules, and program data. Each of the operating system, one or more application programs, other program modules, and program data or some combination thereof, may include an implementation of a networking environment. Program modules 716 generally carry out the functions and/or methodologies of embodiments of the invention as described herein.

Computer system/server 702 may also communicate with one or more external devices 718 such as a keyboard, a pointing device, a display 720, etc.; one or more devices that enable a user to interact with computer system/server 702; and/or any devices (e.g., network card, modem, etc.) that enable computer system/server 702 to communicate with one or more other computing devices. Such communication can occur via Input/Output (I/O) interfaces 722. Still yet, computer system/server 702 can communicate with one or more networks such as a local area network (LAN), a general wide area network (WAN), and/or a public network (e.g., the Internet) via network adapter 724. As depicted, network adapter 724 communicates with the other components of computer system/server 702 via bus 708. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

The embodiments of the present disclosure described herein are implemented as logical steps in one or more computer systems. The logical operations of the present disclosure are implemented (1) as a sequence of processor-implemented steps executing in one or more computer systems and (2) as interconnected machine or circuit engines within one or more computer systems. The implementation is a matter of choice, dependent on the performance requirements of the computer system implementing aspects of the present disclosure. Accordingly, the logical operations making up the embodiments of the disclosure described herein are referred to variously as operations, steps, objects, or engines. Furthermore, it should be understood that logical operations may be performed in any order, unless explicitly claimed otherwise or a specific order is inherently necessitated by the claim language.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. An omnidirectional camera and audio system comprising:
a right eye camera and a left eye camera, the right eye camera including a first set of lenses and the left eye camera including a second set of lenses that correspond to the first set of lenses, wherein a first lens of the set of lenses of the right eye camera captures a first image of an environment and a second lens of the set of lenses of the right eye camera captures a second image of the environment, and wherein the first and second image captured by the right eye camera are captured at a specific degree of difference in relation to a third image captured by the left eye camera; and
at least one processor in operative communication with the right eye camera and the left eye camera, the at least one processor to:
obtain a distance between the first lens of the first set of lenses and the second lens of the first set of lenses;
overlay the first image and the second image, based on the determined distance, to generate at least one overlayed stereoscopic image; and
generate at least a portion of a stereoscopic spherical display based on the at least one overlayed stereoscopic image and the third image.

2. The omnidirectional camera and audio system of claim 1, wherein each lens in the first set of lenses is at least one of an infra-red lens, a ultra-violet lens, a low-light lens and a visual camera lens, wherein each lens in the first set of lenses is a different type of lens than every other lens in the first set of lenses, and wherein each lens in the second set of lenses is a same type of lens as the corresponding lens in the first set of lenses.

3. The omnidirectional camera and audio system of claim 1, further comprising providing the stereoscopic spherical display to a heads up user display orientated to eyes of a user, wherein the stereoscopic image of the stereoscopic spherical display is projected onto the eyes of the user.

4. The omnidirectional camera and audio system of claim 1, further comprising at least one microphone for providing stereoscopic sound that corresponds to the stereoscopic spherical display, the at least one microphone in operable communication with the at least one processor.

5. The omnidirectional camera and audio system of claim 5, wherein the stereoscopic sound is captured directionally and stereoscopically to correlate with the stereoscopic spherical display.

6. The omnidirectional camera and audio system of claim 1, wherein the specific degree of difference is seven degrees.

7. The omnidirectional camera and audio system of claim 1, wherein overlaying the first image and the second image, based on the obtained distance comprises:
generating a first stereoscopic sphere corresponding to the first lens and a second stereoscopic sphere corresponding to the second lens; and
based on the distance, combining the first stereoscopic sphere and the second stereoscopic sphere to generate the at least the portion of the stereoscopic spherical display.

8. A method for generating a stereoscopic spherical display comprising:
obtaining, using at least one processor, a distance between a first lens and a second lens of a first set of lenses included in a right eye camera, wherein the first lens camera captures a first image of an environment and the second camera captures a second image of the environment, and wherein the first and second image captured by the right eye camera are captured at a specific degree of difference in relation to a third image captured by the left eye camera; and
overlaying, using the at least one processor, the first image and the second image, based on the determined distance, to generate at least one overlayed stereoscopic image; and
generating at least a portion of a stereoscopic spherical display based on the at least one overlayed stereoscopic image and the third image.

9. The method for generating a stereoscopic spherical display of claim 8, wherein each lens in the first set of lenses is at least one of an infra-red lens, a ultra-violet lens, a low-light lens and a visual camera lens, wherein each lens in the first set of lenses is a different type of lens than every other lens in the first set of lenses, and wherein each lens in the second set of lenses is a same type of lens as the corresponding lens in the first set of lenses.

10. The method for generating a stereoscopic spherical display of claim 8, further comprising providing the stereoscopic spherical display to a heads up user display orientated to eyes of a user, wherein the stereoscopic image of the stereoscopic spherical display Is projected onto the eyes of the user.

11. The method for generating a stereoscopic spherical display of claim 8, further comprising at least one microphone for providing stereoscopic sound that corresponds to the stereoscopic spherical display, the at least one microphone in operable communication with the at least one processor.

12. The method for generating a stereoscopic spherical display of claim 11, wherein the stereoscopic sound is captured directionally and stereoscopically to correlate with the stereoscopic spherical display.

13. The method for generating a stereoscopic spherical display of claim 8, wherein the specific degree of distance is seven degrees.

14. The method for generating a stereoscopic spherical display of claim 8, wherein overlaying the first image and the second image, based on the determined distance comprises:
generating a first stereoscopic sphere corresponding to the first lens and a second stereoscopic sphere corresponding to the second lens; and
based on the distance, combining the first stereoscopic sphere and the second stereoscopic sphere to generate the at least the portion of the stereoscopic spherical display.

15. A non-transitory compute readable medium including instructions for generating a stereoscopic spherical display, the instructions, executable by a processor, comprising:
obtaining a distance between a first lens and a second lens of a first set of lenses included in a right eye camera, wherein the first lens camera captures a first image of an environment and the second camera captures a second image of the environment, and wherein the first and second image captured by the right eye camera are captured at a specific degree of difference in relation to a third image captured by the left eye camera;
overlaying the first image and the second image, based on the determined distance, to generate at least one overlayed stereoscopic image; and
generating at least a portion of a stereoscopic spherical display based on the at least one overlayed stereoscopic image and the third image.

16. The non-transitory compute readable medium of claim 15, wherein each lens in the first set of lenses is at least one of an infra-red lens, a ultra-violet lens, a low-light lens and a visual camera lens, wherein each lens in the first set of lenses is a different type of lens than every other lens in the first set of lenses, and wherein each lens in the second set of lenses is a same type of lens as the corresponding lens in the first set of lenses.

17. The non-transitory compute readable medium of claim 15, further comprising providing the stereoscopic spherical display to a heads up user display orientated to eyes of a user, wherein the stereoscopic image of the stereoscopic spherical display is projected onto the eyes of the user.

18. The non-transitory compute readable medium of claim 15, further comprising at least one microphone for providing stereoscopic sound that corresponds to the stereoscopic spherical display, the at least one microphone in operable communication with the at least one processor.

19. The non-transitory compute readable medium of claim 18, wherein the stereoscopic sound is captured directionally and stereoscopically to correlate with the stereoscopic spherical display.

20. The non-transitory compute readable medium of claim 15, wherein the specific degree of distance is seven degrees.

21. The non-transitory compute readable medium of claim 15, wherein overlaying the first image and the second image, based on the determined distance comprises:
generating a first stereoscopic sphere corresponding to the first lens and a second stereoscopic sphere corresponding to the second lens; and
based on the distance, combining the first stereoscopic sphere and the second stereoscopic sphere to generate the at least the portion of the stereoscopic spherical display.
